(19) United States
(12) Patent Application Publication
(10) Pub. No.: US 2026/0289038 A1
(43) Pub. Date: Sep. 24, 2026

(54) INFORMATION PROCESSING METHOD AND INFORMATION PROCESSING APPARATUS

(71) Applicant: Kioxia Corporation, Tokyo (JP)

(72) Inventor: Tetsuro WATANABE, Fujisawa (JP)

(73) Assignee: Kioxia Corporation, Tokyo (JP)

(21) Appl. No.: 19/323,382

(22) Filed: Sep. 9, 2025

(30) Foreign Application Priority Data
Mar. 21, 2025 (JP) 2025-047476

(51) Int. Cl. G06F 30/20; G06F 111/06

(52) U.S. Cl. CPC G06F 30/20; G06F 2111/06

(57) ABSTRACT

According to one embodiment, there is provided an information processing method causing an information processing apparatus to execute: generating multiple pieces of model information corresponding to multiple objective variables; generating acquisition function information using the multiple pieces of model information; and generating, based on the acquisition function information, explanatory variable information indicating an explanatory variable for optimization of the multiple objective variables, wherein generating the acquisition function information comprises: obtaining, for each of the multiple objective variables, an importance level of optimizing the objective variable; obtaining, for each of the multiple objective variables, a statistic of evaluations using the model information and an evaluation set for each range of values of the objective variable; and generating the acquisition function information by using the multiple importance levels of optimizing the objective variables and the multiple statistics of the evaluations.

### CROSS-REFERENCE TO RELATED APPLICATIONS

This application is based upon and claims the benefit of Japanese Patent Application No. 2025-047476, filed on Mar. 21, 2025; the entire contents of which are incorporated herein by reference.

### FIELD

Embodiments described herein relate generally to an information processing method and an information processing apparatus.

### BACKGROUND

In an information processing method of optimizing multiple objective variables, it may be difficult to simultaneously optimize all the objective variables, and it is desirable to search for a well-balanced solution in consideration of an importance level for optimization of each objective variable.

### BRIEF DESCRIPTION OF THE DRAWINGS

FIG. 1 is a diagram illustrating a functional configuration of an information processing apparatus to which an information processing method according to an embodiment is applied;

FIG. 2 is a diagram illustrating a hierarchical structure of processing according to the embodiment;

FIG. 3 is a diagram illustrating importance level criterion information according to the embodiment;

FIG. 4 is a diagram illustrating pairwise comparison information of a criterion according to the embodiment;

FIGS. 5A to 5C are diagrams illustrating range setting information for optimization of an objective variable according to the embodiment;

FIG. 6 is a diagram illustrating a range evaluation for optimization of the objective variable according to the embodiment;

FIG. 7 is a sequence diagram illustrating an information processing method according to the embodiment;

FIG. 8 is a diagram illustrating a hardware configuration of an information processing apparatus to which the information processing method according to the embodiment is applied; and

FIG. 9 is a diagram illustrating a functional configuration of an information processing apparatus to which an information processing method according to a modification of the embodiment is applied.

### DETAILED DESCRIPTION

In general, according to one embodiment, there is provided an information processing method causing an information processing apparatus to execute generating multiple pieces of model information corresponding to multiple objective variables. The information processing method causing the information processing apparatus to execute generating acquisition function information using the multiple pieces of model information. The information processing method causing the information processing apparatus to execute generating, based on the acquisition function information, explanatory variable information indicating an explanatory variable for optimization of the multiple objective variables. Generating the acquisition function information comprises obtaining, for each of the multiple objective variables, an importance level of optimizing the objective variable. Generating the acquisition function information comprises obtaining, for each of the multiple objective variables, a statistic of evaluations using the model information and an evaluation set for each range of values of the objective variable. Generating the acquisition function information comprises generating the acquisition function information by using the multiple importance levels of optimizing the objective variables and the multiple statistics of the evaluations.

Exemplary embodiments of an information processing method will be explained below in detail with reference to the accompanying drawings. The present invention is not limited to the following embodiments.

### Embodiment

The information processing method according to the embodiment optimizes multiple objective variables in consideration of an importance level of optimizing each objective variable, and is devised for appropriately searching for a well-balanced solution.

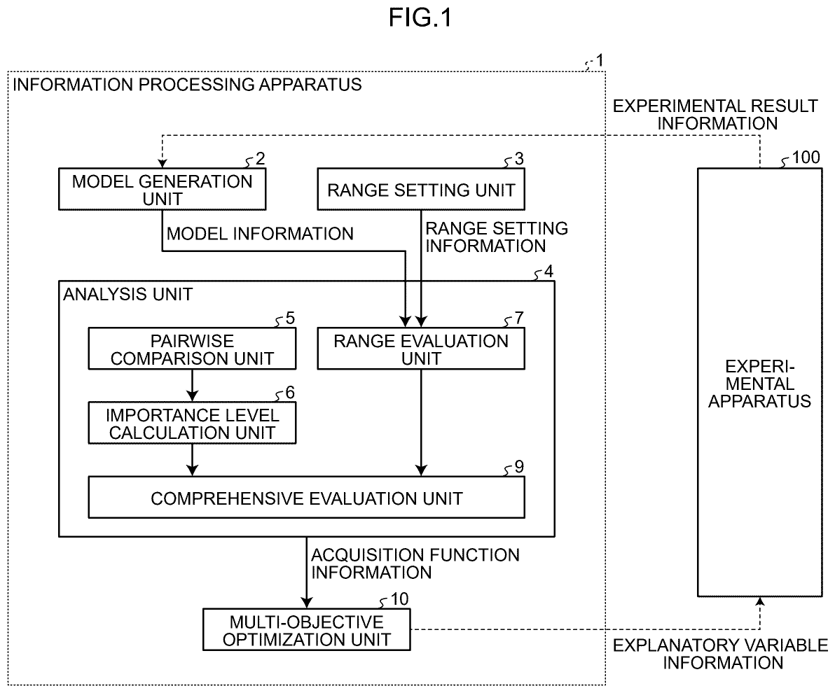

The information processing method may be applied to an information processing apparatus 1 as illustrated in FIG. 1. FIG. 1 is a diagram illustrating a functional configuration of the information processing apparatus 1 to which the information processing method is applied.

The information processing apparatus 1 repeatedly optimizes multiple objective variables related to the design of a semiconductor process and/or design of a semiconductor device.

The information processing apparatus 1 can exchange information with an experimental apparatus 100.

The experimental apparatus 100 performs an experiment related to the design of the semiconductor process and/or the design of the semiconductor device under a condition corresponding to an explanatory variable, and obtains actual measurement values of the multiple objective variables.

The explanatory variable is, for example, a manufacturing condition in the design of the semiconductor process, and the multiple objective variables may be multiple process parameters. The manufacturing conditions may include power supply power of a semiconductor manufacturing apparatus, a power supply frequency of the semiconductor manufacturing apparatus, a power supply pulse period of the semiconductor manufacturing apparatus, a processing gas flow rate of the semiconductor manufacturing apparatus, a processing gas in-plane supply rate of the semiconductor manufacturing apparatus, an auxiliary gas flow rate of the semiconductor manufacturing apparatus, a processing chamber pressure of the semiconductor manufacturing apparatus, a processing time of the semiconductor manufacturing apparatus, a substrate heating temperature of the semiconductor manufacturing apparatus, a chiller temperature of the semiconductor manufacturing apparatus, and the like. Multiple process parameters may be parameters indicating characteristics of a processed cross-sectional shape or parameters indicating characteristics of a processed planar shape. The multiple process parameters may include parameters related to an upper occlusion rate of a cross-sectional shape, a bowing degree of the cross-sectional shape, a twisting degree of the cross-sectional shape, a bending degree of the cross-sectional shape, a tilting degree of the cross-sectional shape, a bottom occlusion rate of the cross-sectional shape, a residual film thickness of a hard mask, a distortion degree of the planar shape, an etching rate, and the like.

The explanatory variable is, for example, an operation terminal condition of a semiconductor device, and the multiple objective variables may be, for example, multiple design parameters in the design of the semiconductor device. The operation terminal condition includes an applied voltage or an applied current to an operation terminal. The multiple design parameters may include a gate voltage/a drain current characteristic, a drain voltage/a drain current characteristic, a substrate voltage/a threshold voltage characteristic, a gate length/a threshold voltage characteristic, a gate width/a threshold current characteristic, a temperature/a threshold current characteristic, a substrate voltage/an on-current characteristic, a gate length/an on-current characteristic, a gate width/an on-current characteristic, a temperature/an on-current characteristic, a gate voltage/a gate capacitance characteristic, a drain voltage/a gate capacitance characteristic, and a substrate voltage/a substrate capacitance characteristic.

The experimental apparatus 100 generates experimental result information indicating an experimental result including an explanatory variable and actual measurement values of multiple objective variables and supplies the experimental result information to the information processing apparatus 1.

The information processing apparatus 1 receives the experimental result information from the experimental apparatus 100. The information processing apparatus 1 obtains an explanatory variable that optimizes multiple objective variables according to the experimental result information, generates explanatory variable information, and supplies the explanatory variable information to the experimental apparatus 100. As an optimization method, for example, a Bayesian optimization method can be used. As a result, the experimental apparatus 100 performs experiment regarding the design of the semiconductor process and/or the design of the semiconductor device again using the explanatory variable information.

In the optimization of the multiple objective variables, the information processing apparatus 1 extracts an explanatory variable X from the explanatory variable information. The explanatory variable X may be provided in plural. The information processing apparatus 1 performs regression analysis (for example, Gaussian process regression) on the explanatory variable X and an objective variable Y, and constructs multiple models corresponding to the multiple objective variables Y. Each model predicts its corresponding objective variable Y from the explanatory variable X. The information processing apparatus 1 generates multiple pieces of model information each indicating a model. The information processing apparatus 1 defines an acquisition function using multiple pieces of model information. The information processing apparatus 1 generates acquisition function information indicating a prescribed acquisition function. The information processing apparatus 1 obtains the explanatory variable X that optimizes the multiple objective variables Y based on the acquisition function information. The information processing apparatus 1 generates explanatory variable information indicating the explanatory variable X.

In the information processing apparatus 1, there are multiple objective variables Y to be optimized. When there are multiple objective variables Y to be optimized, it may be difficult to simultaneously optimize all the objective variables. In this case, it is difficult to appropriately define the acquisition function as to which objective variable among the multiple objective variables Y should be optimized and how much priority should be given, and it is difficult to search for a well-balanced explanatory variable X. Since a “well-balancedness” is a subjective and qualitative index, it is required to reflect the subjective and qualitative index on the acquisition function.

On the other hand, if an idea of an analytic hierarchy process (AHP) is used, it is expected that an acquisition function incorporating subjective and qualitative evaluations can be defined, and as a result, a well-balanced explanatory variable X can be proposed.

The analytic hierarchy process includes an operation of comparing importance (or priority) in a specific criterion for each pair of options for possible options (pairwise comparison for options). However, since the explanatory variables related to the design of the semiconductor process and/or the design of the semiconductor device are usually continuous amounts, there are an infinite number of values (alternatively, pairs of values or a vector) that can be taken as explanatory variables, which are options for optimization of multiple objective variables, and it is difficult to perform a pairwise comparison on the options. For this reason, regarding the analytic hierarchy process, it is desirable to improve the analytic hierarchy process so that evaluation of options can be appropriately performed without performing a pairwise comparison of options.

Therefore, in the present embodiment, in the information processing apparatus 1, the importance level of optimizing each objective variable is obtained for multiple objective variables, the evaluation is set for each range of a value of each objective variable, the statistic of evaluations is obtained using the set evaluation and model information, and the acquisition function information is generated using the multiple importance levels of optimizing the objective variables and the multiple statistics of the evaluations, so that the optimization of definition of an acquisition function and search for a well-balanced solution by the optimization are aimed.

For example, the information processing apparatus 1 includes a model generation unit 2, a range setting unit 3, an analysis unit 4, and a multi-objective optimization unit 10.

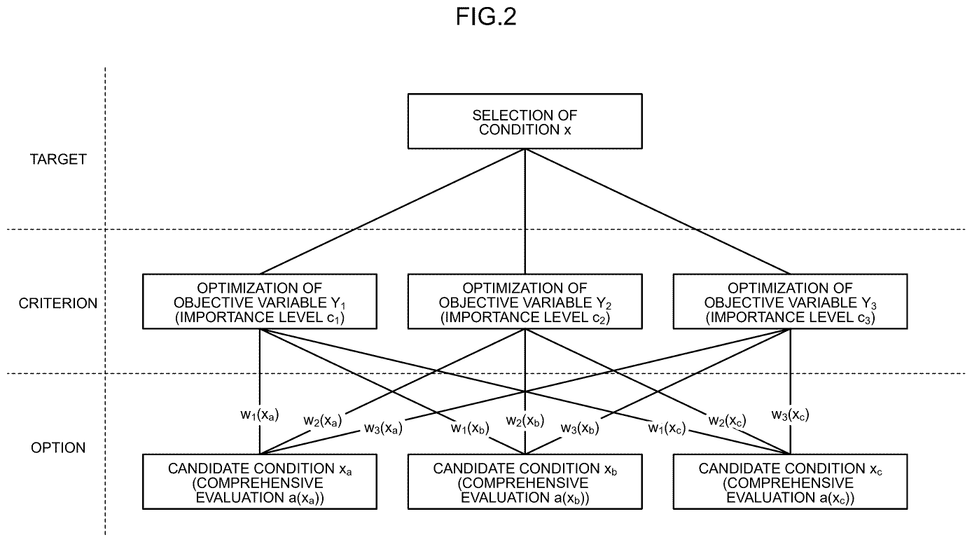

The analysis unit 4 performs improved analysis (hereinafter referred to as analysis A) processing on the analytic hierarchy process such that the options can be appropriately evaluated without performing a pairwise comparison on the options. The processing of the analysis A can be grasped in a hierarchical structure as illustrated in FIG. 2. FIG. 2 is a diagram illustrating a hierarchical structure of processing (analysis A).

The structure of the processing of the analysis A has a three-stage structure including a target, a criterion, and an option. In FIG. 2, “selection of a condition x” is exemplified as a target, “optimization of an objective variable Y₁”, “optimization of an objective variable Y₂”, and “optimization of an objective variable Y₃” are exemplified as criteria, and “a candidate condition xₐ”, “a candidate condition x_{b}”, and “a candidate condition x_{c}” are exemplified as options. Each of the xₐ, x_{b}, and x_{c} is a vector having the same dimension as the number of explanatory variables. Actually, there are an infinite number of such options, but only three of xₐ, x_{b}, and x_{c} are illustrated in FIG. 2 for simplicity.

In the processing of the analysis A, the importance levels of the criteria including “optimization of the objective variable Y₁”, “optimization of the objective variable Y₂”, and “optimization of the objective variable Y₃” are respectively obtained as c₁, c₂, and c₃. In the processing of the analysis A, the evaluations of the option “the candidate condition xₐ” for the criteria including “optimization of the objective variable Y₁”, “optimization of the objective variable Y₂”, and “optimization of the objective variable Y₃” are obtained as w₁(xₐ), w₂(xₐ), and w₃(xₐ), respectively.

The evaluations of the option “candidate condition x_{c}” for the criteria including “optimization of the objective variable Y₁”, “optimization of the objective variable Y₂”, and “optimization of the objective variable Y₃” are obtained as w₁(x_{b}), w₂(x_{b}), and w₃(x_{b}), respectively.

The evaluations of the option “candidate condition x_{c}” for the criteria including “optimization of the objective variable Y₁”, “optimization of the objective variable Y₂”, and “optimization of the objective variable Y₃” are obtained as w₁(x_{c}), w₂(x_{c}), and w₃(x_{c}), respectively.

The analysis unit 4 includes a pairwise comparison unit 5, an importance level calculation unit 6, a range evaluation unit 7, and a comprehensive evaluation unit 9.

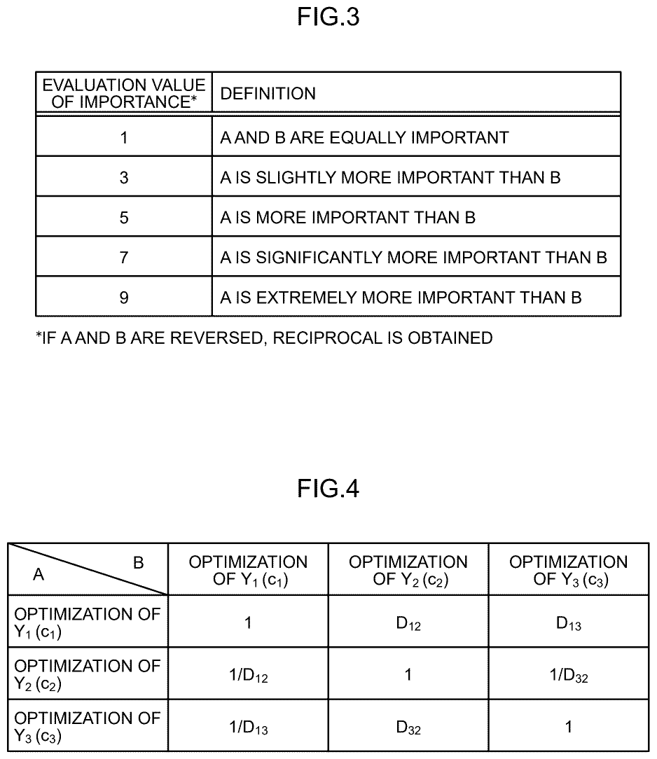

The pairwise comparison unit 5 performs a pairwise comparison for comparing the importance of each criterion for each pair, and obtains the importance level of each criterion. In the example of FIG. 2, the pairwise comparison unit 5 performs a pairwise comparison of the criteria including “optimization of the objective variable Y1”, “optimization of the objective variable Y2”, and “optimization of the objective variable Y3”, and obtains the importance level of each criterion. In the pairwise comparison unit 5, for example, importance level criterion information as illustrated in FIG. 3 is set in advance as an evaluation criterion of the importance level. FIG. 3 is a diagram illustrating the importance level criterion information. As illustrated in FIG. 3, the importance level does not have to be five levels, and any level may be set. In addition, a numerical value assigned to the importance level may not be a numerical value exemplified in FIG. 3, and any numerical value may be set.

As illustrated in FIG. 3, in a case where there are two items A and B to be compared with each other, if A and B are equally important, both an evaluation value of A with respect to B and an evaluation value of B with respect to A are set to 1 in terms of the importance level. If A is more important than B, regarding the importance level, the evaluation value of A with respect to B is 5, and the evaluation value of B with respect to A is the reciprocal thereof, ⅕. If A is extremely more important than B, the evaluation value of A with respect to B is 9, and the evaluation value of B with respect to A is the reciprocal thereof, 1/9 in terms of the importance level.

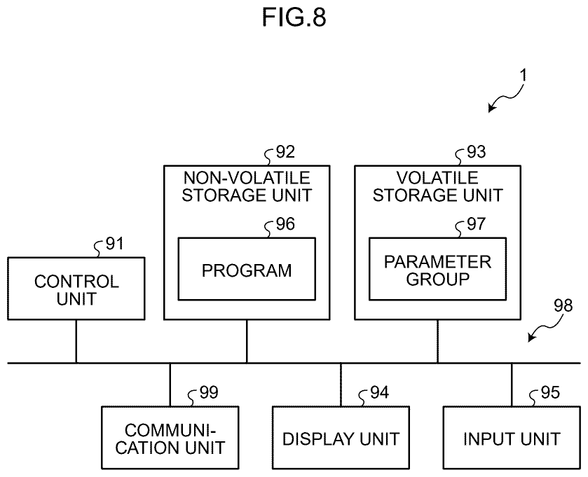

The pairwise comparison unit 5 may display the importance level criterion information as illustrated in FIG. 3 on a display unit 94 (refer to FIG. 8) to present the importance level criterion information to a user, may display information in which an evaluation value in pairwise comparison information as illustrated in FIG. 4 is blank on the display unit 94 (refer to FIG. 8) to prompt the user for input, and may receive the input of the evaluation value from the user to generate the pairwise comparison information as illustrated in FIG. 4. At this time, a description corresponding to the evaluation value may be input into the pairwise comparison unit 5 instead of the evaluation value itself. In addition, the evaluation value and the description corresponding to the evaluation value may be input pairwise comparison unit 5 by a scheme of selection from some candidates. In addition, regarding two items A and B to be compared with each other as a pair, corresponding evaluation values may be input in a form of moving a knob of a slider to a more important side using the slider with A and B at both ends. FIG. 4 is a diagram illustrating pairwise comparison information of a criterion.

FIG. 4 illustrates that the criterion “optimization of the objective variable Y₁” has an evaluation value D₁₂ with respect to the criterion “optimization of the objective variable Y₂”. At this time, the criterion “optimization of the objective variable Y₂” has an evaluation value of 1/D₁₂, which is the reciprocal thereof with respect to the criterion “optimization of the objective variable Y₁”. For example, D₁₂=7 and 1/D₁₂= 1/7 may be satisfied.

As an example, the criterion “optimization of the objective variable Y₁” has an evaluation value D₁₃ with respect to the criterion “optimization of the objective variable Y₃”. At this time, the criterion “optimization of the objective variable Y₃” has an evaluation value of 1/D₁₃, which is the reciprocal thereof with respect to the criterion “optimization of the objective variable Y₁”. For example, D₁₃=3 and 1/D₁₃=⅓ may be satisfied.

The criterion “optimization of the objective variable Y₃” has an evaluation value D₃₂ with respect to the criterion “optimization of the objective variable Y₂”. At this time, the criterion “optimization of the objective variable Y₂” has an evaluation value of 1/D₃₂, which is the reciprocal thereof with respect to the criterion “optimization of the objective variable Y₃”. For example, D₃₂=5 and 1/D₃₂=⅕ may be satisfied.

The pairwise comparison unit 5 supplies the generated pairwise comparison information to the importance level calculation unit 6.

The importance level calculation unit 6 calculates the importance level of each criterion to be compared with the pair based on the pairwise comparison information. In the case of FIG. 2, the importance level calculation unit 6 calculates, based on the pairwise comparison information, the importance level of each of the criteria including “optimization of the objective variable Y₁”, “optimization of the objective variable Y₂”, and “optimization of the objective variable Y₃”.

The importance level calculation unit 6 may calculate the importance level of each criterion by using a principal eigenvector method. In a case where the number of criteria to be compared with each other is m, the importance level calculation unit 6 generates a pairwise comparison matrix P of m rows and m columns based on the pairwise comparison information. In the case of FIG. 2, m=3, and the importance level calculation unit 6 generates a pairwise comparison matrix P of three rows and three columns as illustrated in the following Mathematical Formula 1 based on the pairwise comparison information.

$$( \begin{matrix}1 & {D}_{12} & {D}_{13} \\ 1 / {D}_{12} & 1 & 1 / {D}_{32} \\ 1 / {D}_{13} & {D}_{32} & 1\end{matrix} ) = P \qquad Mathematical Formula 1$$

The importance level calculation unit 6 obtains an eigenvalue λ and an eigenvector q that satisfy Mathematical Formula 2 with respect to the pairwise comparison matrix P. The eigenvector q is a vector that is not a zero vector.

$$Pq = λ q \qquad Mathematical Formula 2$$

The importance level calculation unit 6 can obtain at most m eigenvalues λ satisfying Mathematical Formula 2 with respect to the pairwise comparison matrix P of m rows and m columns, and obtains a maximum eigenvalue λₘₐₓ among the eigenvalues. In the principal eigenvector method, the importance level calculation unit 6 uses an eigenvector qₘₐₓ corresponding to the maximum eigenvalue λₘₐₓ for calculation of the importance level.

At this time, the importance level calculation unit 6 sets m elements of the eigenvector qₘₐₓ corresponding to the maximum eigenvalue λₘₐₓ as importance levels of m criteria, respectively, as expressed in the following Mathematical Formula 3.

$$( \begin{matrix}1 & {D}_{12} & {D}_{13} \\ 1 / {D}_{12} & 1 & 1 / {D}_{32} \\ 1 / {D}_{13} & {D}_{32} & 1\end{matrix} ) ( \begin{matrix}{c}_{1} \\ {c}_{2} \\ {c}_{3}\end{matrix} ) = {λ}_{max} ( \begin{matrix}{c}_{1} \\ {c}_{2} \\ {c}_{3}\end{matrix} ) \qquad Mathematical Formula 3$$

At this time, qₘₐₓ may be normalized such that the sum of m elements becomes 1. In the case of FIG. 2, m=3, and the importance level calculation unit 6 sets the three elements of the eigenvector qₘₐₓ as importance levels c₁, c₂, and c₃ of the criteria including “optimization of the objective variable Y₁”, “optimization of the objective variable Y₂”, and “optimization of the objective variable Y₃”, respectively. At this time, the eigenvector qₘₐₓ is normalized such that the sum of c₁, c₂, and c₃ becomes 1.

When Mathematical Formula 2 is transformed, the following Mathematical Formula 4 is obtained. In Mathematical Formula 4, E is an identity matrix, and 0 on the right side is a zero vector.

Since the eigenvector q is a vector that is not a zero vector, an inverse matrix should not be present in the matrix (P−λE) in Mathematical Formula 4.

$$( P - λ E ) q = 0 \qquad Mathematical Formula 4$$

That is, as expressed in Mathematical Formula 5, the determinant is 0.

$$\vert \begin{matrix}1 - λ & {D}_{12} & {D}_{13} \\ 1 / {D}_{12} & 1 - λ & 1 / {D}_{32} \\ 1 / {D}_{13} & {D}_{32} & 1 - λ\end{matrix} \vert = 0 \qquad Mathematical Formula 5$$

Since Mathematical Formula 5 provides an equation for λ, the importance level calculation unit 6 can obtain the eigenvalue λ by solving this equation. Furthermore, since the eigenvalue λ becomes a real number according to the definition of the pairwise comparison matrix, the maximum eigenvalue λₘₐₓ can be obtained.

The importance level calculation unit 6 can obtain the eigenvector qₘₐₓ corresponding to the maximum eigenvalue Amax by substituting the maximum eigenvalue λₘₐₓ into Mathematical Formula 4 and solving an equation for the eigenvector q. In the case of FIG. 2, m=3, and the importance level calculation unit 6 can respectively obtain the importance levels c₁, c₂, and c₃ as elements of the eigenvector qₘₐₓ. At this time, it is assumed that the eigenvector qₘₐₓ is normalized such that the sum of c₁, c₂, and c₃ becomes 1.

The importance level calculation unit 6 can confirm a consistency index CI of the pairwise comparison information by the following Mathematical Formula 6 using the maximum eigenvalue λₘₐₓ.

$$CI = \frac{{λ}_{max} - m}{m - 1} \qquad Mathematical Formula 6$$

In Mathematical Formula 6, m is the number of criteria. In the case of FIG. 2, m=3. When the consistency index CI obtained by Mathematical Formula 6 is equal to or less than a predetermined value (for example, 0.1), the importance level calculation unit 6 considers that the pairwise comparison information is consistent, generates the importance level information including importance levels c₁, c₂, and c₃ in a form associated with “optimization of the objective variable Y₁”, “optimization of the objective variable Y₂”, and “optimization of the objective variable Y₃”, respectively, and supplies the generated importance level information to the comprehensive evaluation unit 9. The importance level of each criterion may be calculated using a geometric mean, a harmonic mean, or the like without using an eigenvector. The consistency index CI may also be calculated without using an eigenvalue.

The range evaluation unit 7 performs range evaluation for evaluating the objective variable for each range according to the model information. As a preparation therefor, the model information is generated by the model generation unit 2, and the range setting information is generated by the range setting unit 3.

The model generation unit 2 receives experimental result information from the experimental apparatus 100. The model generation unit 2 generates multiple pieces of model information based on the experimental result information. The multiple pieces of model information correspond to multiple objective variables. Each piece of model information is a model that predicts an objective variable from an explanatory variable. The model generation unit 2 extracts an explanatory variable and actual measurement values of multiple objective variables from the experimental result information. The model generation unit 2 generates model information indicating a model for predicting an objective variable from a candidate explanatory variable for each of the multiple objective variables according to the extracted explanatory variable and actual measurement values of the multiple objective variables. The number of explanatory variables may be provided in plural. The model generation unit 2 may perform regression analysis (for example, Gaussian process regression) on the explanatory variable X and the objective variable Y to generate multiple pieces of model information corresponding to the multiple objective variables Y.

The range setting unit 3 sets a criterion evaluation value for each range for each of the multiple objective variables Y, and generates range setting information. In the example of FIG. 2, the range setting unit 3 sets a criterion evaluation value for each range for each of the criteria including “optimization of the objective variable Y₁”, “optimization of the objective variable Y₂”, and “optimization of the objective variable Y₃”, and generates range setting information.

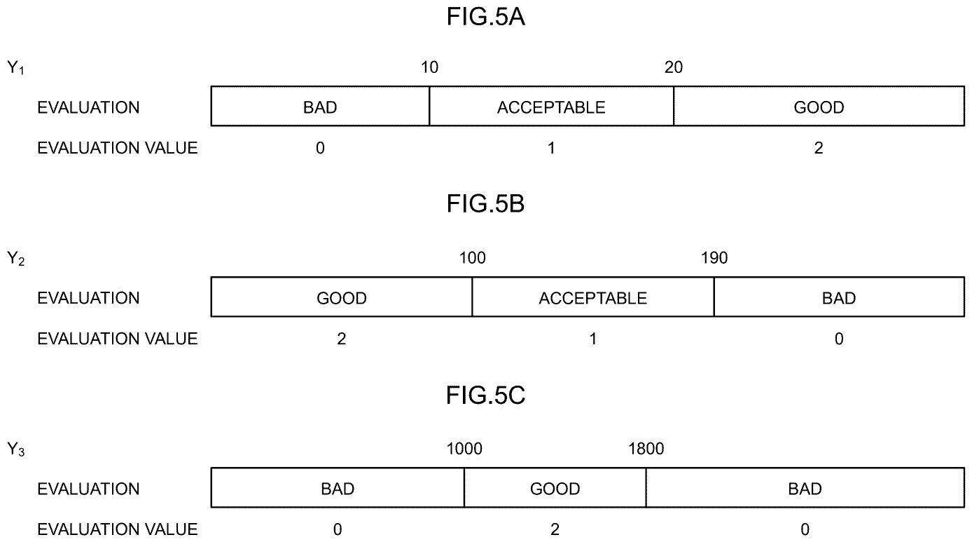

The range setting unit 3 may prompt the user to input by, for example, displaying information in which the evaluation value in the range setting information as illustrated in FIGS. 5A to 5C is blank on the display unit 94 (refer to FIG. 8), and may generate the range setting information as illustrated in FIGS. 5A to 5C by receiving the input of the evaluation value from the user. At this time, the range setting unit 3 may be configured to receive the explanation with respect the evaluation value instead of the evaluation value itself. Alternatively, the range setting unit 3 may be configured to receive the explanation with respect the evaluation value through a scheme of selecting it from some candidates. Alternatively, the range setting unit 3 may be configured to receive the number of division of the range or the change of the boundary of the range from the user. Alternatively, the range setting unit 3 may be configured to generate range setting information by analyzing text data or existing description data that is input from the user to estimate required information. FIGS. 5A to 5C are diagrams illustrating range setting information for optimization of the objective variable. In the range setting information, the number of divisions of the range, the number of evaluation stages, and the criterion evaluation value are not limited to those illustrated in FIGS. 5A to 5C, and can be arbitrarily set.

FIG. 5A illustrates range setting information for the objective variable Y₁. For the optimization of the objective variable Y₁, the range setting unit 3 sets an evaluation value “0” indicating an evaluation “bad” in a case where the range of Y₁ is less than 10, sets an evaluation value “1” indicating an evaluation “acceptable” in a case where Y₁ is 10 or more and less than 20, and sets an evaluation value “2” indicating an evaluation “good” in a case where Y₁ is 20 or more. The range setting unit 3 generates range setting information including evaluation values 0, 1, and 2 for the optimization of the objective variable Y in a form associated with the range of the objective variable Y₁, and supplies the range setting information to the range evaluation unit 7.

FIG. 5B illustrates range setting information for the objective variable Y₂. For the optimization of the objective variable Y₂, the range setting unit 3 sets an evaluation value “2” indicating an evaluation “good” in a case where Y₂ is less than 100, sets an evaluation value “1” indicating an evaluation “acceptable” in a case where Y₂ is 100 or more and less than 190, and sets an evaluation value “0” indicating an evaluation “bad” in a case where Y₂ is 190 or more. The range setting unit 3 generates range setting information including evaluation values 0, 1, and 2 for the optimization of the objective variable Y₂ in a form associated with the range of the objective variable Y₂, and supplies the range setting information to the range evaluation unit 7.

FIG. 5C illustrates range setting information for the objective variable Y₃. For the optimization of the objective variable Y₃, the range setting unit 3 sets an evaluation value “0” indicating an evaluation “bad” in a case where Y₃ is less than 1000, sets an evaluation value “2” indicating an evaluation “good” in a case where Y₃ is 1000 or more and less than 1800, and sets an evaluation value “0” indicating an evaluation “bad” in a case where Y₃ is 1800 or more. The range setting unit 3 generates range setting information including evaluation values 0 and 2 for the optimization of the objective variable Y₃ in a form associated with the range of the objective variable Y₃, and supplies the range setting information to the range evaluation unit 7.

The range evaluation unit 7 receives the model information from the model generation unit 2, and receives the range setting information from the range setting unit 3. The range evaluation unit 7 may obtain the statistic of the evaluation value included in the range setting information according to the range setting information and the model information for each of the multiple objective variables Y. The range evaluation unit 7 extracts multiple ranges to be evaluated and evaluation values of the respective ranges from the range setting information for each of the multiple objective variables Y.

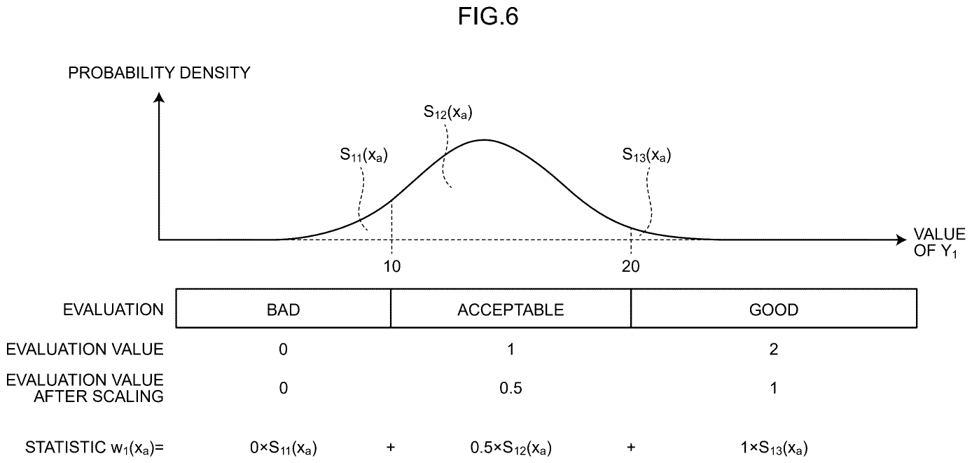

The range evaluation unit 7 obtains a predicted distribution (probability distribution) of possible values of the objective variable Y according to the model information for each of the multiple objective variables Y. FIG. 6 illustrates a predicted distribution of the objective variable Y₁ under the candidate condition xₐ.

For example, multiple ranges for the optimization with respect to the objective variable Y₁ are such that Y₁ is less than 10, 10 or more and less than 20, and 20 or more (refer to FIG. 5A). The range evaluation unit 7 obtains integral values S₁₁(xₐ), S₁₂(xₐ), and S₁₃(xₐ) as integration results regarding the respective ranges.

Multiple ranges for the optimization with respect to the objective variable Y₂ are such that Y₂ is less than 100, 100 or more and less than 190, and 190 or more (refer to FIG. 5B). The range evaluation unit 7 obtains integral values S₂₁(xₐ), S₂₂(xₐ), and S₂₃(xₐ) as integration results regarding the predicted distribution of the objective variable Y₂ under the candidate condition xₐ.

Multiple ranges for the optimization with respect to the objective variable Y₃ are such that Y₃ is less than 1000, 1000 or more and less than 1800, and 1800 or more (refer to FIG. 5C). The range evaluation unit 7 obtains integral values S₃₁(xₐ), S₃₂(xₐ), and S₃₃(xₐ) as integration results regarding the predicted distribution of the objective variable Y₃ under the candidate condition xₐ.

The range evaluation unit 7 performs a product-sum operation of the evaluation value and the integral value of the predicted distribution for each of the multiple objective variables Y. The range evaluation unit 7 obtains the result of the product-sum operation for each of the multiple objective variables Y as a statistic w of the evaluation of the candidate condition x for optimizing the objective variable Y.

For example, in the range evaluation of the objective variable Y₁ in the candidate condition xₐ, as illustrated in FIG. 6, the range evaluation unit 7 may scale the criterion evaluation values “0”, “1”, and “2” for each range where Y₁ is less than 10, 10 or more and less than 20, and 20 or more so as to fall within the range of 0 to 1, and may set the criterion evaluation values as “0”, “0.5”, and “1”, respectively. As expressed in the following Mathematical Formula 7, the range evaluation unit 7 performs the product-sum operation of the evaluation value after the scaling and the integral value of the predicted distribution to obtain a statistic w₁(xₐ) of the evaluation of the candidate condition xₐ for optimizing the objective variable Y₁.

$${w}_{1} ( {x}_{a} ) = 0 \times {S}_{11} ( {x}_{a} ) + 0.5 \times {S}_{12} ( {x}_{a} ) + 1 \times {S}_{13} ( {x}_{a} ) \qquad Mathematical Formula 7$$

For example, in the range evaluation of the objective variable Y₂ in the candidate condition xₐ, the range evaluation unit 7 may scale the criterion evaluation values “2”, “1”, and “0” for each range where Y₂ is less than 100, 100 or more and less than 190, and 190 or more so as to fall within the range of 0 to 1, and may set the criterion evaluation values as “1”, “0.5”, and “0”, respectively. As expressed in the following Mathematical Formula 8, the range evaluation unit 7 performs the product-sum operation of the evaluation value after the scaling and the integral value of the predicted distribution to obtain a statistic w₂(xₐ) of the evaluation of the candidate condition xₐ for optimizing the objective variable Y₂.

$${w}_{2} ( {x}_{a} ) = 1 \times {S}_{21} ( {x}_{a} ) + 0.5 \times {S}_{22} ( {x}_{a} ) + 0 \times {S}_{23} ( {x}_{a} ) \qquad Mathematical Formula 8$$

In the range evaluation of the objective variable Y₃ in the candidate condition xₐ, the range evaluation unit 7 may scale the criterion evaluation values “0”, “2”, and “0” for each range where Y₃ is less than 1000, 1000 or more and less than 1800, and 1800 or more so as to fall within the range of 0 to 1, and may set the criterion evaluation values as “0”, “1”, and “0”, respectively. As expressed in the following Mathematical Formula 9, the range evaluation unit 7 performs the product-sum operation of the evaluation value after the scaling and the integral value of the predicted distribution to obtain a statistic w₃(xₐ) of the evaluation of the candidate condition xₐ for optimizing the objective variable Y₃.

$${w}_{3} ( {x}_{a} ) = 0 \times {S}_{31} ( {x}_{a} ) + 1 \times {S}_{32} ( {x}_{a} ) + 0 \times {S}_{33} ( {x}_{a} ) \qquad Mathematical Formula 9$$

The range evaluation unit 7 supplies the obtained statistic w to the comprehensive evaluation unit 9 in a form associated with candidate conditions such as the “candidate condition xₐ”, the “candidate condition x_{b}”, and the “candidate condition x_{c}” for each of the “optimization of the objective variable Y₁”, the “optimization of the objective variable Y₂”, and the “optimization of the objective variable Y₃”.

The comprehensive evaluation unit 9 receives the importance level information from the importance level calculation unit 6, and receives the statistic information from the range evaluation unit 7. The comprehensive evaluation unit 9 performs comprehensive evaluation using the importance level information and the statistic information. The comprehensive evaluation unit 9 extracts the importance level of optimizing the multiple objective variables from the importance level information. The comprehensive evaluation unit 9 extracts multiple statistics for the candidate condition from the statistic information. The comprehensive evaluation unit 9 performs comprehensive evaluation by using the importance level of optimizing the multiple objective variables and the multiple statistics. A function for performing comprehensive evaluation on the candidate condition x is set as an acquisition function, and acquisition function information indicating the acquisition function is generated.

In the case of FIG. 2, the comprehensive evaluation unit 9 can perform comprehensive evaluation using the importance levels c₁ to c₃ of optimizing the multiple objective variables Y₁ to Y₃ and the statistics w₁(xₐ) to w₃(xₐ) for the candidate condition xₐ as illustrated in the following Mathematical Formula 10. This corresponds to obtaining the value a(xₐ) of the acquisition function with respect to the candidate condition xₐ.

$$a ( {x}_{a} ) = {c}_{1} {w}_{1} ( {x}_{a} ) + {c}_{2} {w}_{2} ( {x}_{a} ) + {c}_{3} {w}_{3} ( {x}_{a} ) \qquad Mathematical Formula 10$$

The comprehensive evaluation unit 9 can perform comprehensive evaluation using the importance levels c₁ to c₃ of optimizing the multiple objective variables Y₁ to Y₃ and the statistics w₁(x_{b}) to w₃(x_{b}) for the candidate condition x_{b} as expressed in the following Mathematical Formula 11. This corresponds to obtaining the value a(x_{b}) of the acquisition function with respect to the candidate condition x_{b}.

$$a ( {x}_{b} ) = {c}_{1} {w}_{1} ( {x}_{b} ) + {c}_{2} {w}_{2} ( {x}_{b} ) + {c}_{3} {w}_{3} ( {x}_{b} ) \qquad Mathematical Formula 11$$

The comprehensive evaluation unit 9 can perform comprehensive evaluation using the importance levels c₁ to c₃ of optimizing the multiple objective variables Y₁ to Y₃ and the statistics w₁(x_{c}) to w₃(x_{c}) for the candidate condition x_{c} as expressed in the following Mathematical Formula 12. This corresponds to obtaining the value a(x_{c}) of the acquisition function with respect to the candidate condition x_{c}.

$$a ( {x}_{c} ) = {c}_{1} {w}_{1} ( {x}_{c} ) + {c}_{2} {w}_{2} ( {x}_{c} ) + {c}_{3} {w}_{3} ( {x}_{c} ) \qquad Mathematical Formula 12$$

The comprehensive evaluation unit 9 generates acquisition function information including definition information of an acquisition function a(x) for any candidate condition x and supplies the acquisition function information to the multi-objective optimization unit 10.

Upon receiving the acquisition function information from the comprehensive evaluation unit 9, the multi-objective optimization unit 10 extracts definition information of the acquisition function a(x) from the acquisition function information. The multi-objective optimization unit 10 may obtain a candidate condition xₙₑₓₜ that maximizes the acquisition function a(x) by a steepest descent method, a stochastic gradient descent method, the limited-memory Broyden-Fletcher-Goldfarb-Shanno (L-BFGS) method, the Nelder-Mead method, a local search method, an annealing method, a covariance matrix adaptation evolution strategy (CMA-ES), a genetic algorithm, a random search, a grid search, or the like.

The multi-objective optimization unit 10 generates explanatory variable information including the candidate condition xₙₑₓₜ and supplies the explanatory variable information to the experimental apparatus 100. As a result, the experimental apparatus 100 can extract the candidate condition xₙₑₓₜ from the explanatory variable information, can perform an experiment regarding the design of the semiconductor process and/or the design of the semiconductor device under the condition, and can obtain actual measurement values of the multiple objective variables.

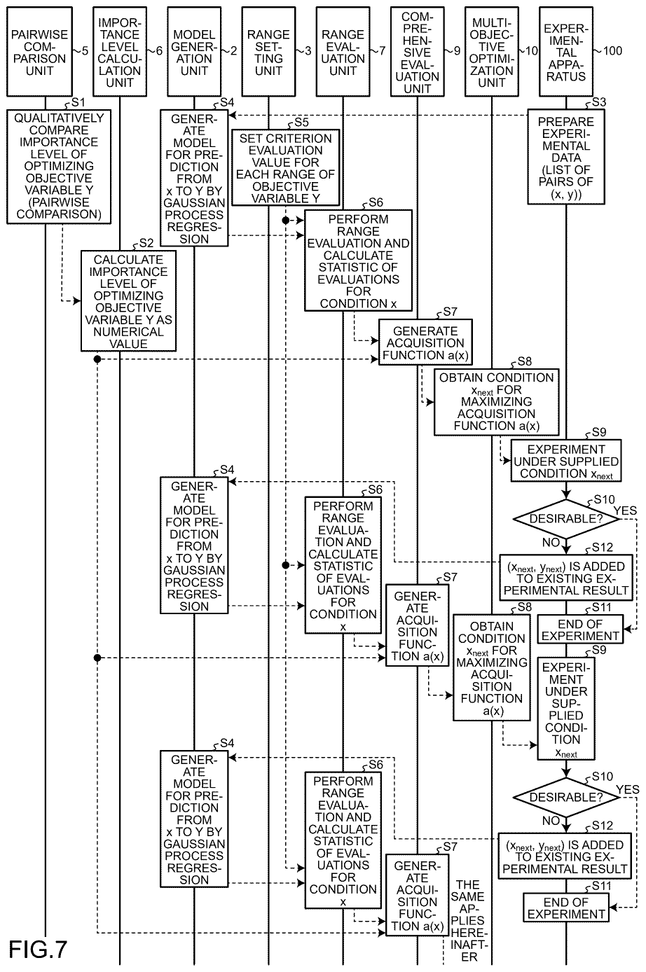

Next, an information processing method according to the embodiment will be described with reference to FIG. 7. FIG. 7 is a sequence diagram illustrating the information processing method.

In the information processing apparatus 1, when an experimental result is supplied from the experimental apparatus 100, the pairwise comparison unit 5 can request a user to perform pairwise comparison for qualitatively comparing an importance level of optimizing the objective variable Y (S1). The pairwise comparison unit 5 supplies a result of the pairwise comparison to the importance level calculation unit 6.

The importance level calculation unit 6 calculates the importance level of optimizing the objective variable Y as a numerical value (S2). The importance level calculation unit 6 supplies the calculated importance level to the comprehensive evaluation unit 9.

Meanwhile, the experimental apparatus 100 prepares an experimental result (a list of pairs of (a condition x and a value of each objective variable Y for the condition x)) (S3). The experimental apparatus 100 supplies an experimental result to the model generation unit 2.

The model generation unit 2 generates a model that predicts the objective variable Y from the condition x by Gaussian process regression (S4). The model generation unit 2 supplies the generated model to the range evaluation unit 7.

In parallel with this, the range setting unit 3 can request a user to set a criterion evaluation value for each range of the objective variable Y (S5). The range setting unit 3 supplies the set criterion evaluation value to the range evaluation unit 7.

The range evaluation unit 7 performs range evaluation using the model and the criterion evaluation value, and calculates a statistic of the evaluation values for the condition x (S6). The range evaluation unit 7 supplies the statistic of the evaluation values to the comprehensive evaluation unit 9.

The comprehensive evaluation unit 9 generates an acquisition function a(x) by using the importance level and the statistic of the evaluation values (S7). The comprehensive evaluation unit 9 supplies the acquisition function a(x) to the multi-objective optimization unit 10.

The multi-objective optimization unit 10 obtains a condition xₙₑₓₜ that maximizes the acquisition function a(x) (S8). The multi-objective optimization unit 10 supplies the condition xₙₑₓₜ to the experimental apparatus 100.

The experimental apparatus 100 performs an experiment under the supplied condition xₙₑₓₜ (S9), and determines whether each desired objective variable Y is obtained as the experimental result (S10).

If the value of each objective variable Y is a desired value (Yes in S10), the experimental apparatus 100 ends the experiment (S11) and notifies the information processing apparatus 1 of the end of the experiment.

When the value of each objective variable Y is not a desired value (No in S10), the experimental apparatus 100 adds an experimental result (pairs of (the condition xₙₑₓₜ and the value of each objective variable Y for the condition xₙₑₓₜ)) of this time to the existing experiment and supplies the result to the information processing apparatus 1.

In response thereto, in the information processing apparatus 1, the processing of S4, S6, and S7 to S12 is repeatedly performed.

Next, a hardware configuration of the information processing apparatus 1 will be described with reference to FIG. 8. FIG. 8 is a diagram illustrating a hardware configuration of the information processing apparatus 1.

The information processing apparatus 1 includes a control unit 91, a non-volatile storage unit 92, a volatile storage unit 93, a display unit 94, an input unit 95, and a communication unit 99. The control unit 91, the non-volatile storage unit 92, the volatile storage unit 93, the display unit 94, the input unit 95, and the communication unit 99 are communicably connected to each other via a bus line 98.

The control unit 91 integrally controls each unit of the information processing apparatus 1. The control unit 91 can be implemented by a central processing unit (CPU) or the like.

The non-volatile storage unit 92 stores a program 96 in a non-volatile manner. The non-volatile storage unit 92 can be implemented by a read only memory (ROM), a flash memory, or the like.

The control unit 91 reads and activates the program 96 from the non-volatile storage unit 92, and executes an information processing method according to the program 96.

The volatile storage unit 93 temporarily stores information. The volatile storage unit 93 may store a parameter group 97 according to the program 96. The volatile storage unit 93 can be implemented by a dynamic random access memory (DRAM) or the like.

The display unit 94 displays the information under the control of the control unit 91. The display unit 94 can be implemented by a display such as a liquid crystal monitor.

The input unit 95 receives information from the outside and supplies the received information to the control unit 91. The control unit 91 may perform processing according to information in accordance with the program 96.

The communication unit 99 can communicate with the outside via a communication link. The communication link may be a wired communication link or a wireless communication link.

All of the model generation unit 2, the range setting unit 3, the pairwise comparison unit 5, the importance level calculation unit 6, the range evaluation unit 7, the comprehensive evaluation unit 9, and the multi-objective optimization unit 10 illustrated in FIG. 1 may be implemented by software. In this case, each of the model generation unit 2, the range setting unit 3, the pairwise comparison unit 5, the importance level calculation unit 6, the range evaluation unit 7, the comprehensive evaluation unit 9, and the multi-objective optimization unit 10 can be implemented as a functional module developed on the volatile storage unit 93 collectively at the time of compiling or sequentially in accordance with the progress of processing in accordance with the activation of the program 96 by the control unit 91.

Alternatively, all of the model generation unit 2, the range setting unit 3, the pairwise comparison unit 5, the importance level calculation unit 6, the range evaluation unit 7, the comprehensive evaluation unit 9, and the multi-objective optimization unit 10 illustrated in FIG. 1 may be implemented as hardware. In this case, each of the model generation unit 2, the range setting unit 3, the pairwise comparison unit 5, the importance level calculation unit 6, the range evaluation unit 7, the comprehensive evaluation unit 9, and the multi-objective optimization unit 10 can be incorporated as a circuit in the control unit 91.

Alternatively, a part of the model generation unit 2, the range setting unit 3, the pairwise comparison unit 5, the importance level calculation unit 6, the range evaluation unit 7, the comprehensive evaluation unit 9, and the multi-objective optimization unit 10 illustrated in FIG. 1 may be implemented as software, and another part thereof may be implemented as hardware.

As described above, in the embodiment, in the information processing apparatus 1, the importance level of optimizing each objective variable is obtained for the multiple objective variables, the evaluation is set for each range of the value of the objective variable for each of the multiple objective variables, the statistic of the evaluations is obtained using the set evaluation and the model information, and the acquisition function information is generated using the importance level of optimizing the multiple objective variables and the multiple statistics of the evaluations. As a result, since the information processing apparatus 1 can use the acquisition function that captures the subjective and qualitative evaluation of the user, it is possible to search for a well-balanced solution (condition) in the optimization of the multiple objective variables Y.

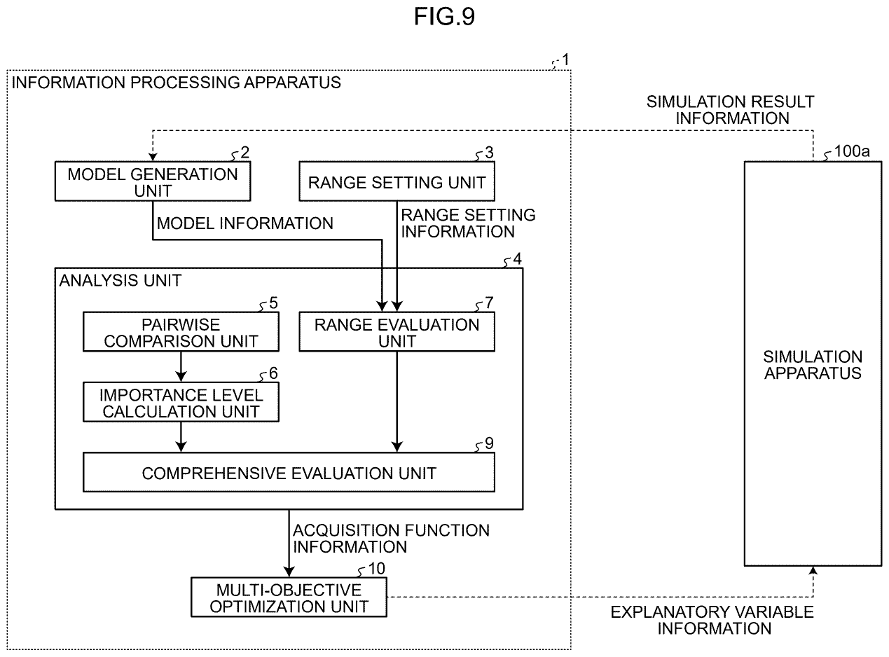

Note that, as illustrated in FIG. 9, the information processing apparatus 1 may be communicably connected to a simulation apparatus 100a instead of the experimental apparatus 100 (refer to FIG. 1). In this case, upon receiving the explanatory variable information from the information processing apparatus 1, the simulation apparatus 100a extracts the explanatory variable from the explanatory variable information, and performs a simulation regarding the design of the semiconductor process and/or the design of the semiconductor device under a condition corresponding to the explanatory variable to obtain a simulation value of the multiple objective variables. The simulation apparatus 100a generates simulation result information indicating a simulation result including an explanatory variable and simulation values of the multiple objective variables and supplies the simulation result information to the information processing apparatus 1.

The information processing apparatus 1 receives the simulation result information from the simulation apparatus 100a. The information processing apparatus 1 obtains a condition for optimizing the multiple objective variables according to the simulation result information, generates explanatory variable information on the condition, and supplies the explanatory variable information to the simulation apparatus 100a. As an optimization method, for example, a Bayesian optimization method can be used. As a result, the simulation apparatus 100a performs the simulation regarding the design of the semiconductor process and/or the design of the semiconductor device again by using the explanatory variable information.

In this configuration as well, the information processing apparatus 1 can search for a well-balanced solution (condition) in the optimization of the multiple objective variables Y.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing method causing an information processing apparatus to execute:
generating multiple pieces of model information corresponding to multiple objective variables;
generating acquisition function information using the multiple pieces of model information; and
generating, based on the acquisition function information, explanatory variable information indicating an explanatory variable for optimization of the multiple objective variables,
wherein generating the acquisition function information comprises:
obtaining, for each of the multiple objective variables, an importance level of optimizing the objective variable;
obtaining, for each of the multiple objective variables, a statistic of evaluations using the model information and an evaluation set for each range of values of the objective variable; and
generating the acquisition function information by using the multiple importance levels of optimizing the objective variables and the multiple statistics of the evaluations.

2. The information processing method according to claim 1, wherein
obtaining the importance level of optimizing the objective variable includes:
performing a pairwise comparison on importance of optimizing the objective variables; and
obtaining the importance level of optimizing the objective variable according to a result of the pairwise comparison, and
obtaining the statistic of the evaluations includes
obtaining, for each of the multiple objective variables, the statistic of the evaluations by using a probability distribution of the objective variable according to the model information and a criterion evaluation value for each range of the values of the objective variable.

3. The information processing method according to claim 2, wherein
obtaining the statistic of the evaluations includes
obtaining, for each of the multiple objective variables, the probability distribution of the objective variable according to the model information.

4. The information processing method according to claim 2, wherein
obtaining the importance level of optimizing the objective variable further includes
confirming a consistency index of the multiple importance levels obtained for the multiple objective variables, and
obtaining the statistic of the evaluations includes
obtaining, when the consistency index complies with a predetermined condition, the statistic of the evaluations for each of the multiple objective variables by using the model information and the evaluation set for each range of the values of the objective variable.

5. The information processing method according to claim 1, wherein
generating the multiple pieces of model information corresponding to the multiple objective variables includes
generating the multiple pieces of model information each including a model that predicts a corresponding objective variable from the explanatory variable.

6. The information processing method according to claim 1, wherein
generating the multiple pieces of model information corresponding to the multiple objective variables includes
generating model information capable of expressing a probability distribution of each corresponding objective variable.

7. The information processing method according to claim 1, wherein
obtaining the statistic of the evaluations includes
performing, for each of the multiple objective variables, a product-sum operation of an integral value for each range of the values of the objective variable and a criterion evaluation value for each range of the values of the objective variable with respect to a probability distribution of the objective variable according to the model information, and obtaining the statistic of the evaluations.

8. The information processing method according to claim 1, wherein
generating the acquisition function information includes
generating, for each of the multiple explanatory variable information serving as candidates for optimization of the multiple objective variables, the acquisition function information using the multiple importance levels of optimizing the objective variables and the multiple statistics of the evaluations.

9. The information processing method according to claim 1, wherein
generating the acquisition function information includes
performing, for each of the multiple explanatory variable information serving as candidates for optimization of the multiple objective variables, a product-sum operation of the importance level of optimizing the objective variable and the statistic of the evaluations, and generating the acquisition function information.

10. The information processing method according to claim 1, wherein
generating the explanatory variable information indicating the explanatory variable for optimization of the multiple objective variables includes
obtaining, based on the acquisition function information, an explanatory variable information that maximizes an acquisition function among multiple pieces of the explanatory variable information that indicate explanatory variables serving as candidates for optimization of the multiple objective variables, and generating the explanatory variable information that indicates the explanatory variable optimizing the multiple objective variables.

11. The information processing method according to claim 1, wherein
the explanatory variable includes a manufacturing condition in design of a semiconductor process, and
the multiple objective variables include multiple process parameters.

12. The information processing method according to claim 1, wherein
the explanatory variable includes an operation terminal condition of a semiconductor device, and
the multiple objective variables include multiple design parameters in design of the semiconductor device.

13. The information processing method according to claim 11, wherein
the manufacturing condition includes at least one condition selected from power supply power of a semiconductor manufacturing apparatus, a power supply frequency of the semiconductor manufacturing apparatus, a power supply pulse period of the semiconductor manufacturing apparatus, a processing gas flow rate of the semiconductor manufacturing apparatus, a processing gas in-plane supply rate of the semiconductor manufacturing apparatus, an auxiliary gas flow rate of the semiconductor manufacturing apparatus, a processing chamber pressure of the semiconductor manufacturing apparatus, a processing time of the semiconductor manufacturing apparatus, a substrate heating temperature of the semiconductor manufacturing apparatus, and a chiller temperature of the semiconductor manufacturing apparatus, and
the multiple process parameters include multiple parameters each indicating a characteristic of a processed cross-sectional shape, multiple parameters each indicating a characteristic of a processed planar shape, or both the multiple parameters.

14. The information processing method according to claim 12, wherein
the operation terminal condition includes an applied voltage or an applied current to an operation terminal, and
the multiple design parameters include parameters selected from a gate voltage/a drain current characteristic, a drain voltage/a drain current characteristic, a substrate voltage/a threshold voltage characteristic, a gate length/a threshold voltage characteristic, a gate width/a threshold current characteristic, a temperature/a threshold current characteristic, a substrate voltage/an on-current characteristic, a gate length/an on-current characteristic, a gate width/an on-current characteristic, a temperature/an on-current characteristic, a gate voltage/a gate capacitance characteristic, a drain voltage/a gate capacitance characteristic, and a substrate voltage/a substrate capacitance characteristic.

15. The information processing method according to claim 13, wherein
the multiple process parameters include parameters selected from parameters related to an upper occlusion rate of a cross-sectional shape, a bowing degree of the cross-sectional shape, a twisting degree of the cross-sectional shape, a bending degree of the cross-sectional shape, a tilting degree of the cross-sectional shape, a bottom occlusion rate of the cross-sectional shape, a residual film thickness of a hard mask, a distortion degree of a planar shape, an etching rate.

16. An information processing apparatus comprising:
an importance level calculation unit that obtains an importance level of optimizing an objective variable for each of the multiple objective variables;
a model generation unit that generates multiple pieces of model information corresponding to the multiple objective variables;
a range evaluation unit that obtains, for each of the multiple objective variables, a statistic of evaluations using the model information and an evaluation set for each range of values of the objective variable;
a comprehensive evaluation unit that generates acquisition function information using multiple importance levels of optimizing the objective variables and multiple statistics of the evaluations; and
a multi-objective optimization unit that generates, based on the acquisition function information, explanatory variable information indicating an explanatory variable that optimizes the multiple objective variables.

17. The information processing apparatus according to claim 16, further comprising
a pairwise comparison unit that performs a pairwise comparison with respect to importance of optimizing the objective variables,
wherein the importance level calculation unit obtains the importance level of optimizing the objective variable according to a result of the pairwise comparison, and
the range evaluation unit obtains, for each of the multiple objective variables, the statistic of the evaluations by using a probability distribution of the objective variable according to the model information and a criterion evaluation value for each range of the values of the objective variable.

18. The information processing apparatus according to claim 17, wherein
the range evaluation unit obtains, for each of the multiple objective variables, a probability distribution of the objective variable according to the model information.

19. The information processing apparatus according to claim 17, wherein
the importance level calculation unit further confirms a consistency index of the multiple importance levels obtained for the multiple objective variables, and
the range evaluation unit obtains, when the consistency index complies with a predetermined condition, the statistic of the evaluations for each of the multiple objective variables by using the model information and the evaluation set for each range of the values of the objective variable.

20. The information processing apparatus according to claim 16, wherein
the model generation unit generates the multiple pieces of model information each including a model that predicts a corresponding objective variable from the explanatory variable.
